(19) United States
(12) Patent Application Publication
(10) Pub. No.: US 2026/0180987 A1
(43) Pub. Date: Jun. 25, 2026

(54) Method for Enabling Restriction of a Sensor of a Wireless Communication Device in a Certain Geographical Location

(71) Applicant: Telefonaktiebolaget LM Ericsson (publ), Stockholm (SE)

(72) Inventor: Amin Azari, Järfälla (SE)

(21) Appl. No.: 19/124,701

(22) PCT Filed: Oct. 28, 2022
(86) PCT No.: PCT/SE2022/050987

§ 371 Date: Apr. 25, 2025

(51) Int. Cl. H04L 9/40

(52) U.S. Cl. CPC H04L 63/10

(57) ABSTRACT

A communication system (400), a network node (420) and a method performed by the network node. The method (500) is for enabling a restriction of a sensor of a wireless communication device (430, 430A, 430B, 430C), WD. The method comprising receiving (510) a first request for a sensor restriction service wherein the first request comprises information indicative of a geographic location (001) wherein the sensor restriction service is to be performed, determining (520) a radio access node (425, 425A, 425B, 425C) which provides wireless communication in the geographical location (001); and sending (560), to the radio access node, information comprising any one or more of: configuration information (543) for the WD, configuration information (547) for the sensor of the WD, configuration information (553) for the radio access node. Computer programs and computer program products are also disclosed.

### TECHNICAL FIELD

The disclosure herein relates to a communication system, a network node, and methods thereof. In particular, the embodiments relate to enabling a restricting of a sensor of a wireless communication device. A computer program and a computer program product are also disclosed.

### BACKGROUND

The privacy of users has been in focus in the design of new technologies and services. Due to the evolution of personal low-cost compact sensors, for examples cameras or microphones, capable of recording information ranging from video and audio to smell and taste and the widespread deployment thereof combined with advances in Artificial Intelligence (AI) for extracting an identity of a person from different sources, preserving privacy has become more complicated and complex. Taking into considerations the accumulation of the information from sensors, and the potential for immoral actors utilizing the information for their benefit, without consent, there has been a recent shift of regulating the collecting and processing of such data, e.g., General Data Protection Regulation (GDPR) in Europe.

There are some solutions focusing on the prevention of the recording of data, to enable privacy standards that society is willing to embrace. For example, U.S. Pat. No. 93,890,225 B2 discloses a technology for stopping smartphone cameras from being used at selected locations, e.g., concerts, using infrared emitters.

However, these solutions generally require human intervention by the installation of special devices at these locations. The scalability of such solutions is also limited.

### SUMMARY

An object of the invention is to improve a restriction possibility of a sensor of a wireless communication device.

According to a first aspect there is provided a method performed by a network node. The method is for enabling a restriction of a sensor of a wireless communication device (WD). The method comprises receiving a first request for a sensor restriction service. The first request comprises information indicative of a geographic location where the sensor restriction service is to be performed. The method further comprises determining a radio access node which provides wireless communication in the geographical location, and sending information, to the radio access node. The information comprises any one or more of: configuration information for the WD, configuration information for the sensor of the WD, configuration information for the radio access node.

Hereby is achieved that configuration information related to the WD and/or the radio access node may be received by the radio access node from the WD.

According to a second aspect there is provided a network node for enabling a restriction of at least one sensor of a WD. The network node comprises a communication interface, a processing circuitry and a memory. The memory stores instructions that, when executed by the processing circuitry, cause the network node to receive a first request for a sensor restriction service, determine at least one radio access node which provides wireless communication in the location, and send, to the radio access node, information comprising any one or more of configuration information for the WD, configuration for the sensor of the WD, configuration information for the radio access node. The first request comprises information indicative of a geographic location wherein the sensor restriction service is to be performed.

According to a third aspect there is provided a computer program. The computer program comprises program code to be executed by at least one processor circuitry of a network node, whereby the execution of the program code causes the network node to perform the operations according to the first aspect or any embodiments thereof.

According to a fourth aspect there is provided a computer program product. The computer program product comprises a computer program according to the third aspect. The computer program product further comprises a computer readable means on which the computer program is stored.

According to a fifth aspect there is provided a communication system for enabling a restriction of a sensor of a WD. The communication system comprises a network node, according to the second aspect, and a radio access node. The radio access node is configured to receive information to enable the sensor restriction service and send configuration information to a WD or a sensor of a WD.

In an embodiment of the first aspect, the method comprises sending, to an authorization entity, a second request for authorization of the first request for a sensor restriction service, and receiving, from the authorization entity, a confirmation of the second request.

In an embodiment of the first aspect, the method comprises identifying at least one WD within the geographic location indicated in the first request, with the one or more sensors. In such an embodiment, the method may comprise, for one or more of the at least one identified WD with the sensor, determining if the identified WD is a collaborative device. In such an embodiment the method may comprise, determining if the network node has direct control of the sensor of the identified WD. Furthermore, in such an embodiment, the method may comprise, in addition or as an alternative to the determining if the identified WD is a collaborative device, and/or if the network node has direct control of the sensor comprises, for each identified WD, determining a control level for the at least one sensor of the identified WD.

In an embodiment of the first aspect, the method comprises sending a third request to a detection module. The third request requests information indicative of an identify of at least one WD indicated to be violating the sensor restriction service. The method comprises, receiving information indicative of an identity of at least one WD indicated to be violating the sensor restriction service. In this embodiment, the method may comprise sending instructions to the radio access node to disconnect the at least one WD violating the sensor restriction service.

In an embodiment of the second aspect, the network node is configured to send a second request to an authorization entity and receive a confirmation of the second request from the authorization entity. The second request requests authorization of the first request for the sensor restriction service.

In an embodiment of the second aspect the network node is configured to identify at least one WD with the at least one sensor within the geographic location indicated in the first request. In such an embodiment, the network node may be configured to, for one or more of the at least one identified WD with the sensor, determine if the identified WD is a collaborative device. In such an embodiment, the network node may be configured to determine if the network node has direct control of the sensor of the identified WD. In an alternative embodiment, the network node is configured to, for one or more identified WD, determine a control level for the at least one sensor of the identified WD.

In an embodiment of the second aspect, the network node is configured to send a third request to a detection module and receive information indicative an identity of at least one WD violating the sensor restriction service. The third request requests information on a WD violating the sensor restriction service. In said embodiment, the network node may be configured to send instruction to the radio access node to disconnect at least one WD corresponding to the indicated identity in response to receiving the information indicative of an identity of a WD violating the sensor restriction service.

In an embodiment of the second aspect the network node is configured to send a message to inform a sender of the first request for the sensor restriction service, of at least one violation of the sensor restriction service.

In an embodiment of the first and second aspect the at least one sensor is any one of a camera, a microphone, a motion sensor, an accelerometer, a gyroscope, a positioning system receiver, an odor detector, a flavor detector.

A further advantage of embodiments of the invention is the detection of a WD violating a sensor restriction service.

### BRIEF DESCRIPTION OF THE DRAWINGS

The disclosure is now described, by way of example, with reference to the accompanying drawings, in which:

FIG. 1 illustrates an example of a location for a sensor restriction service;

FIG. 2 is a block diagram of a network node according to embodiments;

FIG. 3 is a flowchart illustrating an example of a method for enabling sensor restriction;

FIG. 4 illustrates an example of a wireless communication network;

FIGS. 5 and 6 are block diagrams of collaborative devices according to embodiments;

FIG. 7 is a block diagram of a collaborative sensor;

FIG. 8 is a signaling diagram of signaling between modules for enabling a sensor restriction service.

### DETAILED DESCRIPTION

The disclosure will now be described more in detail hereinafter with reference to the accompanying drawings, in which certain embodiments of the disclosure are shown. This disclosure may, however, be embodied in many different forms and should not be construed as limited to the embodiments set forth herein; rather, these embodiments are provided as examples of embodiments within the claimed scope.

An objective of the invention is to enable a restriction possibility of information from a sensor by a network node in a wireless communication network.

A known problem is how to restrict a sensor usage in a location where non-collection of information is enforced or required, for example at concerts, security sites, crime scenes and accidents. A restriction of the sensor may be used to protect information, for example, infrastructure information, people's identities and/or personal information, from being recorded and distributed to the public.

The disclosure provides a solution to the above-mentioned problem. An advantage of the invention is that it enables the restriction, e.g., of the collection and/or distribution of information, from a sensor of a wireless device (WD). A restriction of information that is able to be collected by at least one sensor may be enabled by for example, restricting the ability of a sensor to capture information or restricting the distribution of information captured by a sensor. As used herein restricting of information implies disabling a sensor, parts thereof, or features of the sensor, to capture information. Alternatively, or in addition to, restriction of information further implies disabling a device from communicating, or distributing, captured information while within an indicated location. Furthermore, the restricting of information can also be performed by disabling all or parts of a sensor, or disabling features of a sensor or a device to limit information that can be captured by the device. An example of disabling a sensor's ability to capture information would be wherein a microphone capable of capturing audio information is turned off, or in-activated. An example wherein disabling a device from communicating or distributing captured information while within an indicated location may be where a wireless communication signal to and from a device is not allowed i.e., disabled, or the WD is restricted from connecting to the network through a radio base station, and therefore information that is attempted to be transmitted from a device to a radio base station is not further processed in the communication network. An example where disabling parts of a sensor or a device's ability to capture information would be where, in an area, a camera (a device's sensor) would attempt to use a flash-photography to capture more information using the camera, but the restriction is to disable the flash of the WD (a part of the device) to restrict the information that is able to be captured by the camera. Another example of disabling parts, or features, of a sensor would be if you have a barometer or thermometer performing at a specific precision, e.g., 1013.74 hPa, or 23.24° C. respectively. Both are here indicated to be performing at two decimal accuracy. The restriction performed on the barometer or thermometer in the example above, is to disable the accuracy of these sensors to thereby limit the data captured by the device. For example, if the barometer is restricted to display pressure to the nearest 10^{th} place, the barometer would read, 1010 hPa, and if the thermometer was restricted to display temperature rounded up to the nearest interval of 5, the example thermometer would display 25° C.

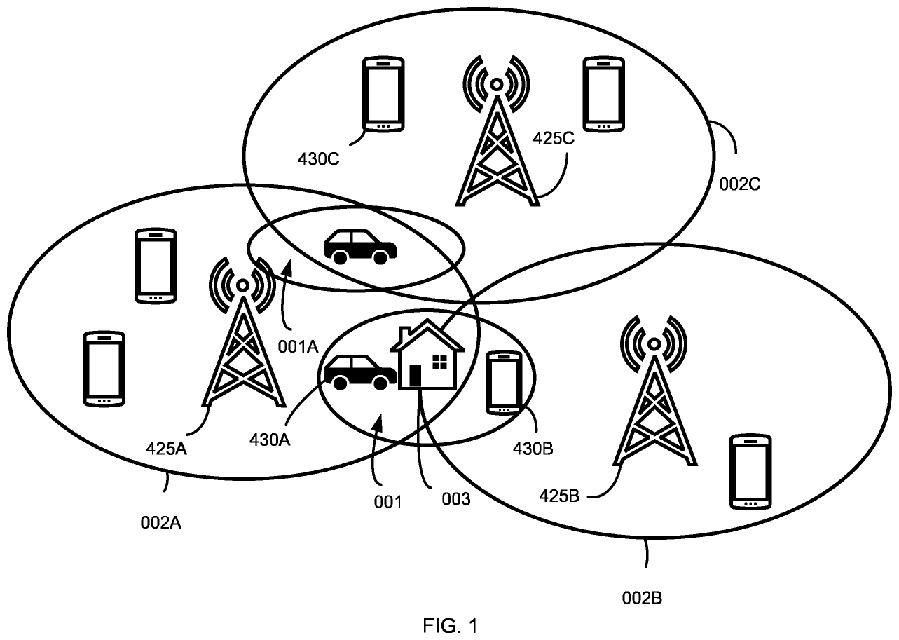

In FIG. 1 there is illustrated an example of geographical coverage cells 002A, 002B, 002C of a communication network wherein WDs 430A, 430B, 430C, and base stations 425A, 425B, 425C, operate. Further illustrated are geographical locations 001, 001A located within the communication network's geographical coverage cells 002A, 002B, and 002C wherein there is a restriction on information from a sensor. In other words, the geographical locations 001 and 001A are within a geographical coverage cell of a base station and have a sensor restriction service enabled. Therefore, in the geographical locations 001 and 001A information that may be captured by a WD is to be restricted.

The restriction may be applied as stated above, e.g., either by disabling the acquisition of the information by the sensor, or by restricting the WD from transmitting the information outside the geographical location where the sensor restriction service is while the WD is in the geographical locations 001 and 001a. For example, geographical location 001 is an area around a security installation 003, e.g., a military encampment, a police station, or other security installation, wherein there is a need to restrict the ability to photograph and/or perform other measurements. Alternatively, or in addition, the geographical location 001 is any geographical location where there is a desire to restrict information capture by a sensor, e.g., a cinema, a concert hall, a public event, a sprots arena or event area. In the example shown in FIG. 1, WD 430A, e.g., a self-driving car utilizing a camera, and WD 430B, e.g., a smartphone with a camera and a microphone, are located within the geographical location 001, which may be the security installation described above. Due to the sensitive information present and/or the restrictions due to legal provisions regarding capturing information about the installation, there is a need to suppress the WD's 430A, 430B ability to photograph the security installation 003. Furthermore, geographical location 001A is illustrated to be an area or volume surrounding a mobile vehicle, such as a car, train, truck, unmanned aerial vehicle, drone, lorry, military vehicle, or other vehicle comprising a mobile WD, wherein a sensor restriction should take place.

There is a need to be able to manage sensors at specified geographical locations, more specifically to restrict the acquisition of sensitive information. Furthermore, it may be desirable to enable the acquisition of such information in certain specific circumstances. As used herein, the term “geographical location” refers to an area/volume that could be identified on a two dimensional or three-dimensional map, using for example, geographical coordinates, such as latitude and longitude or latitude, longitude and altitude; positioning information from a satellite-based positioning system such as Global Positioning System (GPS), Galileo, GLONASS, and BeiDou; and triangulation or information found in e.g., a Radio Resource Control (RRC) message, e.g., RRC_active or RRC_inactive messages to a Core Network (CN).

A sensor restriction service is a service taking place, enforced, and/or is effective in the geographical location, wherein a restriction of information acquired by a sensor is desired. The restriction of information is ordered or requested by for example local regulations, third party service providers, law enforcements or/and privacy guidelines, i.e., active actors or passive instructions. The restriction relates to the prohibition and/or the limitation for WDs in the geographical location to acquire, and/or distribute information capturable by sensors, for example, video, audio, odors, speed, pressure, humidity, temperature and/or tastes.

The radio access node 425 (not indicated in FIG. 1), e.g., base station 425A, 425B, 425C of FIG. 1, provide connectivity to WDs within a geographical coverage, for example including geographic coverage cells 002A, 002B, 002C. Within a geographical coverage cell, one or more WDs are present. Each WD has access to one or more information capturing sensor. An information capturing sensor could be a camera, a microphone or other information capturing devices, e.g., an external thermometer capturing information regarding temperature, an olfactory detector capturing smells, a motion sensor detecting motion, an accelerometer detecting acceleration, a gyroscope measuring orientation or angular velocity, a positioning system receiver determining a position.

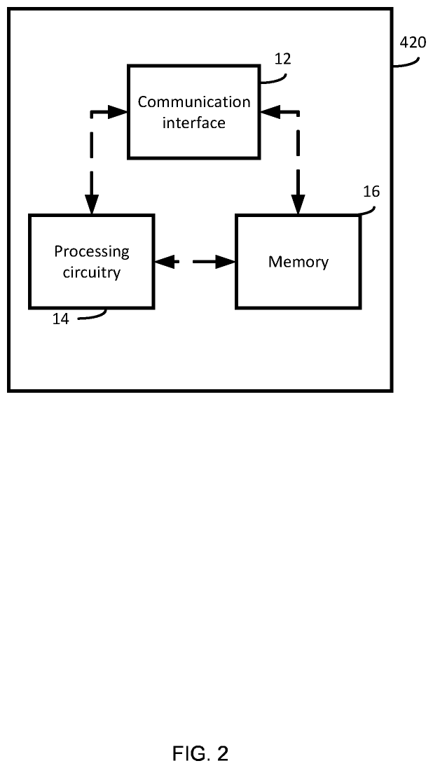

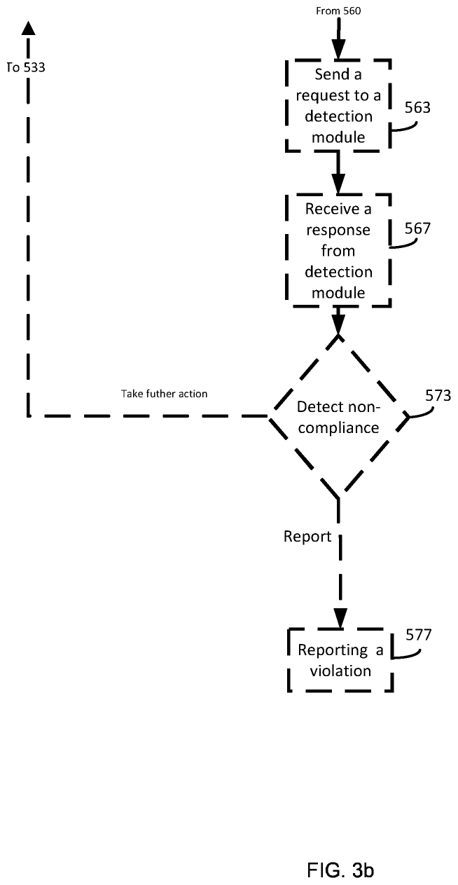

FIG. 2 illustrates a network node 420. The network node is in a communication network 400, illustrated in FIG. 4. The network node 420 comprises at least one communication interface 12, at least one processing circuitry, 14, and at least one memory 16.

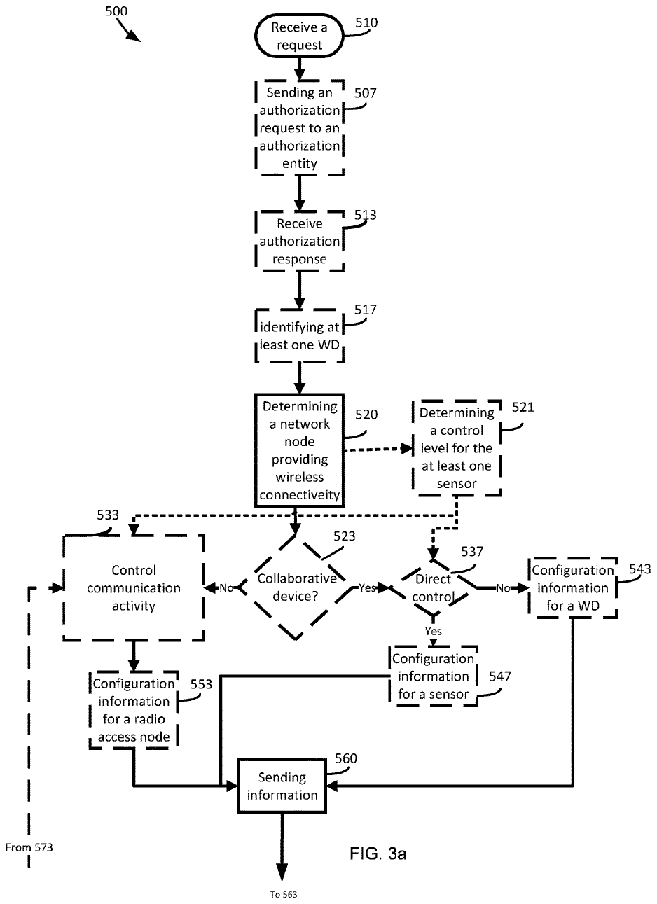

FIG. 3 illustrates a method 500, performed by the network node 420, for enabling a restriction of information of at least one sensor of a WD.

In a first step, the network node 420 receives 510 a first request for a sensor restriction service, wherein the first request comprises information indicative of a geographic location 001 wherein the sensor restriction service is to be performed. In an embodiment, the first request for a sensor restriction service is provided by a third party device 410, see FIG. 4. Alternatively, the first request may be retrieved or provided from an information storage e.g., a local database or an online database. The information storage could be accessed using HTTP GET/POST messages. In an embodiment the request may be provided to the network node 420 by another (different) network node. The first request may be described as a request for a sensor restriction service, called in the following a sensor restriction service request.

In another step, the network node 420 determines 520 at least one radio access node, that provide wireless connectivity within the indicated geographic location wherein the sensor restriction service is to be performed.

In another step, the network node sends 560 to the radio access node, information to enable the sensor restriction service.

The information sent to enable the sensor restriction service may include one or more of configuration information. The configuration information may be configuration information for the WD 543, or configuration information for the sensor of the WD 547, or configuration information for the radio access node 553, or any combination of one or more of the mentioned configuration information. For example, the sensor restriction service may be to restrict the WD from recording information using the WD's sensor(s), or to have the WD configure the WD's sensor(s) to not capture specific types of information. Furthermore, the configuration information 547 for a sensor, e.g., a sensor with a Wake-up receiver (WuR) 800 module, may include a code to be sent to the sensor. For example, the code may include on/off keying used for example as amplitude-shift keying in sending digital data in a carrier wave, wherein the information may be sent using an encoded signal. In another example, the code “01110101110” may be used as an activation code and the code “0010010010” may be used as a deactivation code. Other code variations, combinations, and code lengths may be used to indicate activation and/or deactivation of the sensor. The configuration information for a radio access node may for example comprise instructions to restrict all communication across the network for a specific region. In an embodiment, the configuration information of a radio access node may comprise information indicating specific WDs to be denied service, for example to enforce a non-transmit policy. Thereby, the configuration information for a radio access node enables a restriction on the spread of information captured by a sensor within the geographical location for the entire duration that the WD is located within the geographic location. Thereby either or both the restriction on the capture and the restriction of the spread of information may be enabled for a WD within the location.

In an optional step, the network node sends 507 a second request to an authorization entity. The second request is a request for authorization of the received first request. The authorization entity for example, a Network Exposure Function (NEF), confirms the authenticity of the first request. For example, the first request is provided from a source having the authority to perform the requested sensor restriction service. To continue processing the first request, after sending a second request, the network node receives 513 a confirmation of the authenticity of the first request from the authorization entity. The confirmation indicates that the sensor restriction service is to be further processed. The second request may be described as an authorization request, or a request for authorization.

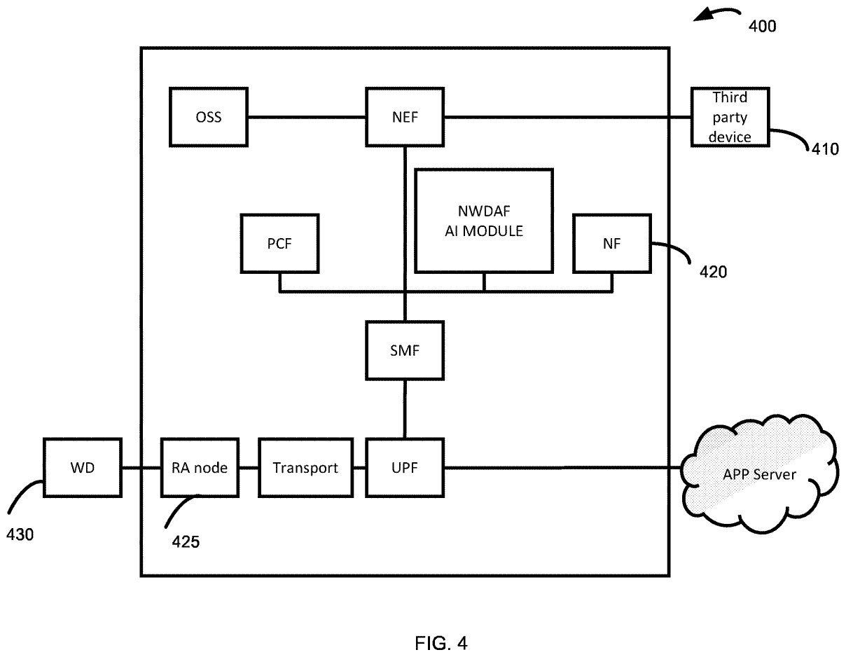

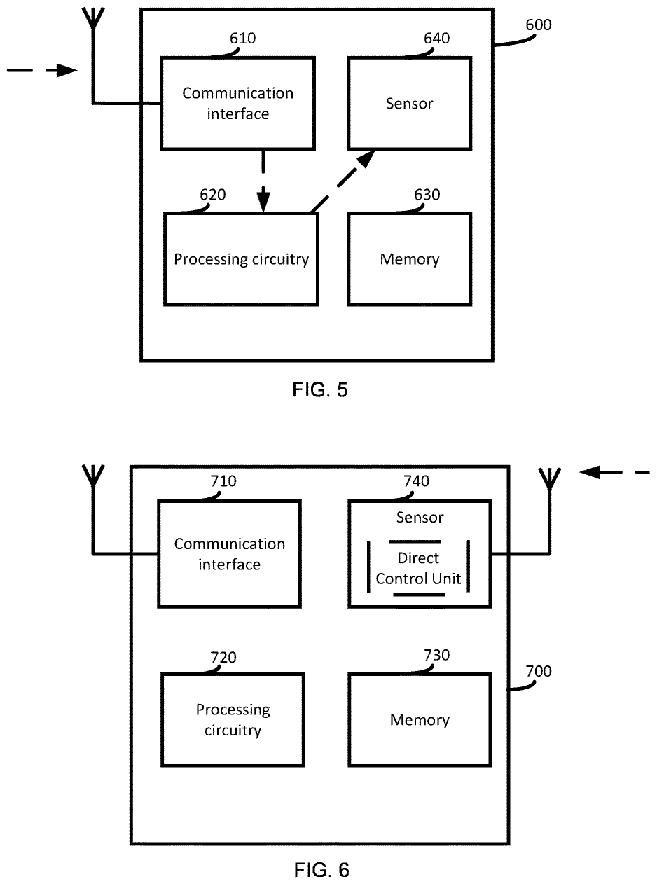

In an optional step, the network node identifies 517 at least one WD with at least one sensor, the WD located within the geographic location indicated in the first request. This is performed, for example, by requesting information of WDs from the identified radio access node, or by monitoring traffic passing through specified gateways, or by monitoring RRC_Inactive/RRC_Active messages, or by any combination of the above. In embodiments, the identifying of a WD is performed, for example, by sending a querying message, to an access and mobility management function (AMF), to retrieve information based upon radio parameters associated with a temporary identification number associated with a WD. The temporary identification number is a temporary identification for a WD enabling anonymity for a device but enables a radio access (RA) node to identify, temporarily, a WD. In a further step, the network node may, for one or more of the identified WD, determine 523 if the WD is a collaborative device 600, 700 (see FIGS. 5 and 6).

A collaborative device 600, 700 is a WD with a sensor, wherein the sensor is able to be controlled by means of instructions from the network node. In an embodiment the sensor is controlled by a radio access node sending instructions to the WD, the collaborative device 600, and the collaborative device implements the received instructions for the sensor, for example to limit or disable the capture of information by the sensor. Thus, the configuration of the sensor is performed by having the WD receiving configuration information 543, and the configuration information instructing the WD to configure the sensor to enable the desired restriction. Alternatively, the network node controls the sensor by communicating directly with the sensor itself, e.g., using a WuR, as in collaborative device 700. The configuration of the sensor is performed by having the sensor receive configuration information 547 directly from the radio access node. None, either or both alternatives are possible for a WD. An example of where both alternatives are enabled for a device is where the sensor is configured by the network node directly to restrict the capture of information, and further restrictions are enabled by instructing the WD to further configure the sensor to enable the desired further restrictions. For example, the sensor is configured to only capture information of a certain quality, e.g., a camera is enabled to only capture at 30 frames per second, and the device configures to disable the flash of the camera.

In an optional step, the network node determines 537 whether the at least one sensor is a direct controlled sensor. A direct controlled sensor is a sensor that is controlled directly from the RA node without sending configuration information through a WD, in other words, a direct controlled sensor is a sensor which receives configuration instructions from the RA node. An example of a direct access sensor is a sensor coupled to a WuR module. Thus, the network node has direct control of the sensor.

Configuration information may comprise an instruction to turn off or turn on a sensor and may be sent directly to the sensor of the wireless device, without the instruction being processed by the WD.

A sensor of a WD may be comprised within a body of the WD, i.e., as an integral structure within the WD, e.g., an embedded camera or microphone inside a smartphone, or an embedded accelerometer. In another embodiment, the sensor is connected to the WD through wires, or wirelessly, for example a GoPro camera communicating through Wi-Fi or Bluetooth to the WD, e.g., a smartphone, or a headset comprising a microphone enabling an audio recording system connected to the WD. In other words, a WD with a sensor may be wirelessly connected or wired to the sensor.

In some embodiments, the network node may have different measures of control over restrictions able to be enforced on the communication device and sensor, i.e., may be of different types. Therefore, the network node may, in an optional step determine a measure of control the network node has, for the at least one sensor of the WD. Herein, the measure of the amount of control can be termed as a control level and is further described below. In other words, the network node may determine 521 a control level for the at least one sensor of the WD. A device that has a sensor that is able to be controlled is referred to herein as a collaborative device.

A first control level is where a device has a sensor that is able to be controlled by a network. For example, the first control level can be considered as a first measure of control that has full, or total control. In other words, the network has direct control over the one or more sensor. For example, some mobile phones require the mobile phone to be enrolled (registered) with a work profile (e.g., specific allocation of certain resources or required software for the phone to be functional as intended). The work profile may through configuration of the device and/or using a required software, enable a third party (the owner of the work profile) to enable/disable specific sensors through the network.

A second control level is where neither the device nor the sensor are able to be controlled by a configuration message from the network node. For example, the second control level can be a second measure of control that is considered as a control of none, or no control. In this case, the network/network node is not aware of the potential of the device.

An even further control level may be where the network has partial control over a sensor, or features thereof, on demand. Said further control level can be a third measure of control that is considered as limited, or limited control. For example, a microphone wherein the device can specify how the information is captured but not disable or enable capturing of the information, another example is wherein a sensor can only be turned off, but a sensor cannot be turned on. In an embodiment, another control level may be the WD having control over some but not all sensors in a WD. For example, another control level is a fourth measure of control over only the camera and/or microphone, but not over a positioning system receiver, or an odor sensor, wherein all sensors are comprised within one WD. Yet another further control level may be wherein the network is able to configure the wireless device, but not any sensors comprised within the wireless device. For example, the network can instruct the WD to not store any information captured by a sensor, but cannot prohibit the sensor from capturing information, or vice versa, wherein the network node instructs the WD to store, or transmit, all information captured by a sensor, but cannot configure the sensor to begin capture information. Thereby a fifth measure of control is place over the device, but not over the sensors within the device.

There may be a variety of control levels defined upon a per user basis, a user's preferences or other factors that expand beyond the control levels described above.

If a WD is not a collaborative device, i.e., a non-collaborative device, there is provided another embodiment where the network node performs an action(s) to restrict the WD with the sensor. For example, a feature of the communication activity of the WD is managed, e.g., restricted, increased or disabled. The communication activity that can be manage, may be e.g., bandwidth or resource allocation, and connectivity services. This is enabled by the network node sending 560 configuration information 553 to one or more radio access nodes, i.e., radio base stations, that the WD is communicating with. Thereby, the network node is controlling 533 a feature of the communication activity.

It is foreseen that in some scenarios, there exists malicious WDs that only pretend to comply with the sensor restriction service. Therefore, in some embodiments, the detection of a WD which is violating the sensor restriction service is desired. In other words, it is desired to detect 573 that a WD that is non-compliant with the sensor restriction service. Thus, in an optional step, the network node sends a third request to a detection module 563. The third request 563 to the detection module is a request for information regarding or for information indicating i.e., an indication, that a WD is violating the sensor restriction service. For example, there is a restriction on recording pictures, audio, and/or sound or other information from an area such as a concert, and, contrary to the restriction, there is one or more WDs that capture information and attempt to share it across the wireless communication network. Any such WD that share, or attempt to share, the captured information is violating the sensor restriction service, i.e., the requirements to comply with the sensor restriction service are being breached. The information specifying the sensor restriction service is further provided to the detection module, to facilitate for example, a detection process by the detection module. The information for the sensor restriction service could for example, be information dictating a policy, e.g., no flash photography, or no audio/video capturing, etc. In a further embodiment, the information specifying the sensor restriction service is provided alongside the third request or in a separate information message sent to the detection module. Optionally, the third request may be termed as a request for information regarding the violation of the sensor restriction service, or a violation information request.

In the case that a WD that is violating the restriction is sending information across the wireless communication network, the detection module identifies this information by monitoring wireless communication traffic information. The monitored wireless communication traffic information may be information relating to the information that is intended to be restricted, e.g., information associated with pictures, audio, video, temperature, pressure, smells, and other sensory information capturable by a sensor. The monitored wireless communication traffic information is monitored at for example, one or more gateways through which information from the WD located within the geographical location indicated in the first request passes. In some embodiments, the detection module is a rule-based module following instructions to monitor certain sensor restriction policies. Alternatively, the detection module is an Artificial Intelligence (AI) module, e.g., a module provided with a trained dataset used for detecting violation of sensor restriction policies. In an embodiment, the detection module will, e.g., in response to the first request from the network node, provide the network node with information inferred or obtained from monitoring the wireless communication traffic. The provided information indicating the identity of a WD indicated to be violating the sensor restriction service. In other words, the network node receives 567 a response from the detection module, the response indicating a WD, by indicating the WD's identity.

In an embodiment, the network node sends 577 a message to inform a sender of the first request for a sensor restriction service that a violation and/or a failure with the implementation of the sensor restriction service has been detected. Thereby informing the sender or request of the first request of any detected violations so that other measures may be readily implemented. A failure to implement the sensor restriction service would be for example where there is an error in communicating with the identified wireless device and/or sensor. If there is an error in communicating with the identified wireless device and/or sensor such that the sensor restriction service cannot be enforced on the desired devices and/or sensor. Thus, information indicating such a failure may be desirable to enable other measures to be implemented, or as feedback to perform further failure analysis.

FIG. 4 illustrates an example of a wireless communication network in which the network node 420 is implemented. Wireless communication networks embrace different standards of networks, for example Wideband Code Division Multiple Access, 3^{rd} Generation (3G), Long Term Evolution (LTE), 4^{th} Generation, New Radio (NR), 5^{th} Generation (5G) and future standards. The network node 420 is indicated as being a standalone network node but could of course be introduced into any of the network nodes in the wireless communication network suitable for supporting the operations. Furthermore, in some embodiments the third-party device 410 (as illustrated in FIG. 4) is directly connected to the NEF, in an alternative embodiment the third party device 410 communicates directly, i.e., is connected, to the RA node 425 and instigate the sensor restriction service through a first request sent through the series of network nodes provided within the wireless communications network. The WD communications with the communication network 400 through the RA node 425.

Optionally, the function(s) of the network node are distributed in an environment spanning several network nodes each performing an individual step of the method. For example, a first network node may process the third-party requests. After which the first network node sends the first request with a second request for authorization to the authorization module. The authorization module sends the confirmation of the authorization request to a second network node. The second network node further indicates a third network node, e.g., a node relevant for the indicated geographical location. The third network node determine further relevant network nodes, e.g., gNodeB, which are in direct communication with WDs, and construct the configuration information to be sent to the further relevant network nodes. There may of course be more network nodes performing other steps in-between, e.g., further forwarding steps or confirmation and authorization steps. In some embodiments a network node is a virtualized network node.

In the present context, the term virtualizing means creating virtual versions of apparatuses or devices e.g., virtualizing hardware platforms, storage devices and networking resources. Naturally, virtualization can be applied to any device described herein, or components thereof, suitable for virtualization and relates to an implementation in which at least a portion of the functionality is implemented as one or more virtual components.

FIG. 5 and FIG. 6 are block diagram of examples of collaborative WDs, referred to herein as a collaborative device 600, 700. FIG. 5 illustrates a collaborative device with indirect access to the sensor connected to the WD. The collaborative device 600 comprises a communication interface 610, a processing circuitry 620, and a memory 630. A sensor 640 is shown for simplicity as being comprised within the collaborative device 600 but can of course be connected through wired or wireless means (not shown) to the collaborative device 600. The collaborative device 600 is a collaborative device where the communication interface 610 receives information in the form of a wireless communication signal. The information is, for example, processed by the processing circuitry 620 and is used to configure the sensor 640. Optionally, the information is stored in the memory for the duration of the sensor management service. In an embodiment, the information is configuration information instructing the WD to restrict a sensor of the WD.

FIG. 6 illustrates a collaborative device 700 wherein the sensor 740 is directly accessed. The collaborative device comprises a communication interface 710, processing circuitry 720 and a memory 730. The collaborative device 700 is a collaborative device as the sensor can be e.g., turned off and on directly without the other parts of the WD performing any processing, after receiving configuration instructions e.g., through an antenna coupled to the sensor.

The processing circuitry 620, 720 includes one or more processors, e.g., one or more general purpose microprocessors, one or more data processing circuits, e.g., an application specific integrated circuit, and/or one or more field-programmable gate arrays. In an embodiment, the processing circuitry is located in a single housing or a data center. Alternatively, the processing circuitry is geographically distributed. In some embodiments the communication interface 610, 710, comprises a transmitter and a receiver for enabling transmissions of data. The transmissions are sent to and/or from the communication interface. The transmissions are transmitted to network nodes, e.g., a RA node, or to other WDs within reach of direct transmissions to and from the WD. The communication interface, and parts thereof are connected to one or more antennas. In some embodiments, the transmitter and receiver share circuit components, software, and firmware, e.g., if implemented in a joint transceiver. The memory 630, 730 is a generic data storage system, which in some embodiments include one or more non-volatile storage device and/or one or more volatile storage devices.

The memory 630, 730 is or comprises a computer program product for storing information. In some embodiments the memory includes one or more computer readable storage medium in the form of non-volatile memories, and/or one or more volatile memories such as random-access memory or cache. A computer readable storage medium can be a non-transitory computer readable medium, e.g., DVD, flash memory. The computer program product stores a computer program which comprises computer instructions or code. The computer instructions of the computer program are configured so when executed by processors the computer instructions cause the device to perform some or all the functions and operations described herein.

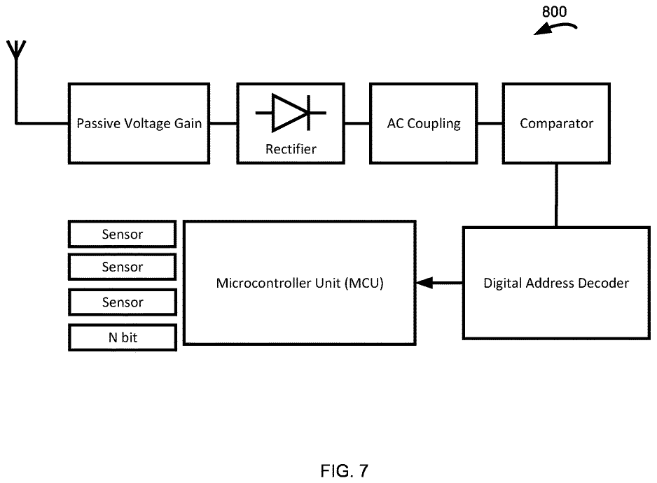

For example, FIG. 7 illustrates an example of a control unit 800 that is used to directly control a sensor. The control unit comprises an antenna, a passive voltage gain, a rectifier, an AC coupling, a comparator, a digital address decoder, and a microcontroller unit (MCU). A signal is received at the antenna and the information comprised therein is amplified by the passive voltage gain. The information comprised within the signal passes through and is the rectifier, the ac coupling, the comparator, and the digital address decoder into the MCU wherein it is decoded to manage the sensor(s) coupled to the MCU. This enables the sensor to be configured while circumventing the WD.

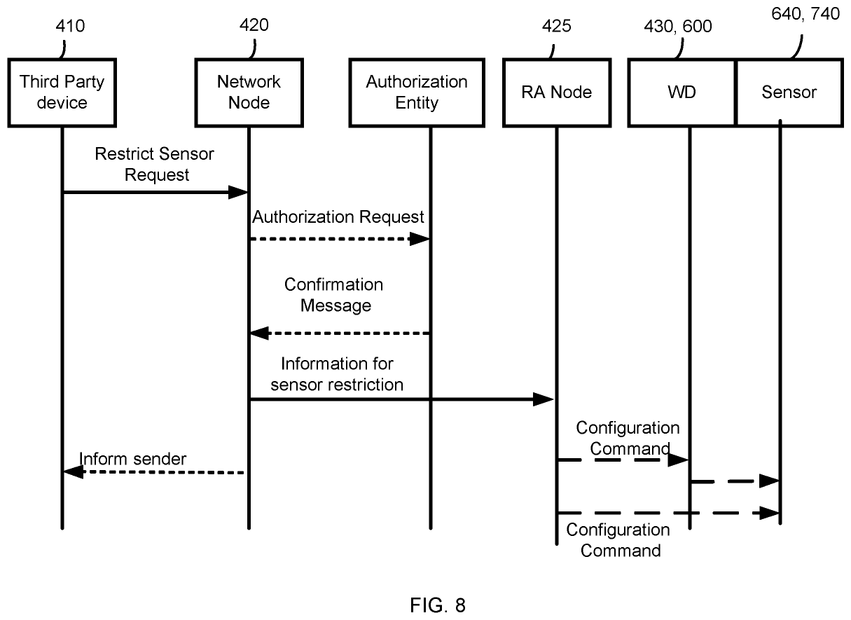

FIG. 8 illustrates an example signaling diagram for implementing the sensor restriction service. In a first step the third-party device 410 sends a first request to a network node 420, for example the network function illustrated in FIG. 4. This information is further sent to the radio access node 425 which sends configuration commands i.e., signals with configuration instructions, that enable the restriction of the sensor of the WD. In a first embodiment these signals are sent to the WD 430, 600, and from there the sensor 640 is configured by the WD. Optionally, the configuration command is sent directly to the sensor 740 comprised within WD 700.

The various embodiments described herein may be implemented by means of a recording medium readable by a computer or its similar device by employing for example, software, hardware, or combinations thereof.

A software implementation of the embodiments described may be implemented as procedures and functions that may be implemented in separate modules and/or computer program parts, each of which is written to cause a computer system to perform one or more of the functions and operations described herein. Software code may be implemented using a software application written in any suitable programming language.

As used herein the term WD, which may alternatively be known as a “wireless terminal” or a “User Equipment” (UE), may refer to a mobile phone, a cellular phone, a Personal Digital Assistant (PDA), equipped with radio communications capabilities, a smart phone, an iPad, a USB dongle e.g. with a radio modem, a laptop or a personal computer, PC, equipped with an internal or external mobile broadband modem, a tablet PC with radio communication capabilities, a laptop embedded equipment, a laptop mounted equipment, a device-to-device UE, a machine type UE, a UE capable of machine-to-machine communications, customer premises equipment, a portable electronic radio communication device, a sensor device equipped with radio communication capabilities. As further way of example the WD may be a transportation vehicle, wherein a transportation vehicle may be a bicycle, a motor bike, a scooter, a moped, an auto rickshaw, a rail transport, a train, a tram, a bus, a car, a truck, an airplane, a boat, a ship, a ski board, a snowboard, a snow mobile, a hoverboard, a skateboard, a roller-skate (or a pair of roller-skates), a vehicle for freight transportation, a drone, an unmanned aerial vehicle, an automated guided vehicle, a robot, a stratospheric aircraft, an aircraft, a helicopter and a hovercraft. In a further example, the WD may be a telematics unit within a vehicle, a vehicle-mounted or vehicle embedded wireless device, a VR headset, a display, a loudspeaker, or other wirelessly connected media delivery device, etc. In particular, the term “WD” should be interpreted as a non-limiting term comprising any type of wireless device communicating with a radio network node in a cellular or a mobile communication system. As such, a WD may be any of a wide variety of communication devices arranged, configured, and/or operable to communicate wirelessly with the network node.

The radio access node may be a radio base station in the form of a standardized base station such as NodeB or evolved NodeB (eNB), for Long Term Evolution (LTE) or gNodeB for New Radio (NR). It will be appreciated that the term radio access node may further refer to a base transceiver station, an access point, a network control node such as a network controller, a radio network controller, a base station controller, and the like or some combination thereof. The radio access node may, in an embodiment, be a modem, hub, bridge, switch or other data communication equipment, or a data terminal equipment such as a host computer.

It is to be understood that the singular form “a,” “an,” and “the” include plural referents unless the context clearly dictates otherwise. It will be further understood that the terms, “comprises” “comprising”, “includes” and/or “including” when used herein, specify the presence of stated features, integers, steps, operations, elements, and/or components, but do not preclude the presence or addition of one or more other features, integers, step, operations, elements, components, and/or groups thereof.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is comprised by the disclosure unless otherwise indicated herein or otherwise clearly contradicted by context. Additionally, while the processes described above and illustrated in the drawings are shown as a sequence of steps this was done for the sake of illustration only, unless otherwise stated. It is contemplated that some steps may be added, some steps omitted, the order of the steps may be re-arranged, and some steps may be performed in parallel.

1-26. (canceled)

27. A method for enabling a restriction of a sensor of a wireless communication device (WD), the method being performed by a network node, the method comprising:
receiving a first request for a sensor restriction service, wherein the first request comprises information indicative of a geographical location wherein the sensor restriction service is to be performed;
determining a radio access node which provides wireless communication in the geographical location; and
sending, to the radio access node, information comprising one or more of:
configuration information for the WD;
configuration information for the sensor of the WD;
configuration information for the radio access node.

28. The method of claim 27 wherein the method comprises:
sending, to an authorization entity, a second request for authorization of the first request for the sensor restriction service; and
receiving, from the authorization entity, a confirmation of the second request.

29. The method of claim 27, wherein the method comprises:
identifying one or more WD, within the geographical location indicated in the first request, with one or more sensor.

30. The method of claim 29, wherein the method comprises, for one or more identified WD, determining a control level for the at least one sensor of the identified WD.

31. The method of claim 29, wherein the method comprises: determining if the network node has direct control of the sensor of the identified WD.

32. The method of claim 27, wherein the method comprises:
sending a third request, to a detection module, for information indicative of an identify of at least one WD indicated to be violating the sensor restriction service; and
receiving information indicative of an identity of at least one WD violating the sensor restriction service.

33. The method of claim 32, wherein the method comprises:
sending instructions to the radio access node to disconnect from the network the at least one WD indicated to be violating the sensor restriction service.

34. The method of claim 27, wherein the method comprises:
sending a message to inform a sender of the first request for the sensor restriction service of at least one violation of the sensor restriction service

35. The method of claim 27, wherein the method comprises:
sending a message to inform a sender of the first request for the sensor restriction service of at least one failure of implementing the sensor restriction service.

36. The method of claim 27, wherein the sensor is one or more of a camera, a microphone, a motion sensor, an accelerometer, a gyroscope, a positioning system receiver, an odor detector, a flavor detector.

37. A network node for enabling a restriction of at least one sensor of a wireless communication device (WD); the network node comprising:
a communication interface;
a processing circuitry; and
a memory storing instructions that, when executed by the processing circuitry, cause the network node to:
receive a first request for a sensor restriction service, wherein the first request comprises information indicative of a geographical location wherein the sensor restriction service is to be performed;
determine at least one radio access node which provides wireless communication in the geographical location; and
send, to the radio access node, information comprising any one or more of:
configuration information for the WD;
configuration information for the sensor of the WD;
configuration information for the radio access node.

38. The network node of claim 37, wherein the network node is configured to:
send, to an authorization entity, a second request for authorization of the first request for the sensor restriction service; and
receive a confirmation of the second request from the authorization entity.

39. The network node of claim 37, wherein the network node is configured to:
identify at least one WD, within the geographical location indicated in the first request, with at least one sensor.

40. The network node of claim 39, wherein the network node is configured to:
for one or more identified WDs, determine a control level for the at least one sensor of the identified WD.

41. The network node of claim 37, wherein the network node is configured to:
send, to a detection module, a third request for information on a WD violating the sensor restriction service; and
receive information indicative of an identity of at least one WD violating the sensor restriction service.

42. The network node of claim 41, wherein the network node is configured to:
send instructions to the radio access node to disconnect at least one WD corresponding to the indicated identity, in response to receiving the information indicative of an identity of a WD violating the sensor restriction service.

43. The network node of claim 37, wherein the network node is configured to:
send a message to inform a sender of the first request for the sensor restriction service of at least one violation of the sensor restriction service.

44. The network node of claim 37, wherein the network node is configured to:
send a message to inform a sender of the first request of at least one failure of implementing the sensor restriction service.

45. The network node of claim 37, wherein the sensor is one or more of a camera, a microphone, a motion sensor, an accelerometer, a gyroscope, a positioning system receiver, an odor detector, or a flavor detector.

46. A communication system for enabling a restriction of a sensor of a wireless communication device (WD), the communication system comprising a network node of claim 38 and a radio access node configured to:
receive information to enable the sensor restriction service; and
send configuration instructions to a sensor of a WD or a WD.
